(19) United States
(12) Patent Application Publication
(10) Pub. No.: US 2024/0196100 A1
(43) Pub. Date: Jun. 13, 2024

(54) Gated Camera, Motor Vehicle Having Such a Gated Camera, and Method for Operating Such a Gated Camera

(71) Applicant: Daimler Truck AG, Leinfelden-Echterdingen (DE)

(72) Inventor: Fridtjof STEIN, Ostfildern (DE)

(21) Appl. No.: 18/571,027

(22) PCT Filed: Jun. 14, 2022
(86) PCT No.: PCT/EP2022/066146

§ 371 Date: Dec. 15, 2023

(30) Foreign Application Priority Data
Jun. 18, 2021 (DE) 10 2021 003 160.1

(51) Int. Cl. H04N 23/74; B60Q 1/00; B60Q 1/24; B60R 11/04

(52) U.S. Cl. CPC H04N 23/74; B60Q 1/0023; B60Q 1/249; B60R 11/04

(57) ABSTRACT

A gated camera has at least one lighting device and an optical sensor. The at least one lighting device has at least one degree of freedom such that the at least one lighting device is rotatably mounted in relation to at least one rotational axis relative to the optical sensor.

### BACKGROUND AND SUMMARY OF THE INVENTION

The invention relates to a gated camera, to a motor vehicle having such a gated camera and to a method for operating such a gated camera.

Known gated cameras and/or known methods for operating gated cameras waste a lot of energy, in particular energy in the form of light pulse photons, on the basis of unadjusted components—in particular of unadjusted lighting devices.

To improve a gated camera, a more light-sensitive optical sensor and/or more light-sensitive lens can be used. Disadvantageously, these components of a gated camera become larger and more expensive, the more light-sensitive they are designed to be. Alternatively, or additionally, a brighter lighting device can be used for improving a gated camera. Disadvantageously, the lighting device becomes larger and more expensive, the brighter it is designed to be.

The invention is based on the object of providing a gated camera, a motor vehicle having such a gated camera and a method for operating such a gated camera, wherein the mentioned disadvantages are preferably avoided, or at least partially resolved.

The object is solved by providing the present technical teaching, in particular the teaching of the independent claims as well as the embodiments disclosed in the dependent claims and the description.

The object is solved in particular by providing a gated camera having at least one lighting device and an optical sensor. The at least one lighting device has at least one degree of freedom such that the at least one lighting device is rotatably mounted in relation to at least one rotational axis relative to the optical sensor.

Advantageously, it is thus possible to light the user-defined regions of an object-side scene by means of the at least one lighting device and thus to record the user-defined regions of the object-side scene by the means of the gated camera. In addition, an opening angle of the at least one lighting device can be advantageously reduced in order to align a lighting frustum of the at least one lighting device onto the user-defined region of the object-side scene. Therefore, it is advantageously possible to design the at least one lighting device to be smaller and more cost-effective than a conventional lighting device. Alternatively, the radiant intensity of the at least one lighting device can be increased by means of the reduction of the opening angle. Thus, a detection accuracy of the gated camera can be advantageously increased.

In the context of the present technical teaching, a conventional lighting device is arranged in the gated camera such that it is not displaceable in relation to the optical sensor. The opening angle of the conventional lighting device therefore determines an illuminable region of the object-side scene.

By means of a gated camera, a method for generating recordings by means of a temporally coordinated actuation of the at least one lighting device and of the optical sensor is carried out. Such a method is known in particular as a gated imaging method; in particular, the optical sensor is a camera which is sensitively triggered only in a specific, limited time period, which is referred to as “gated control.” Also, the at least one lighting device is correspondingly temporally actuated only in a specific, chosen time interval, in order to illuminate an object-side scene, in particular a visible distance range.

In particular, the at least one lighting device is set up in order to emit a predefined number of light pulses, preferably lasting between 5 ns and 20 ns. In addition, the optical sensor in particular is set up in such a way that a beginning and an end of the exposure of the optical sensor are coupled to the number and duration of the emitted light pulses and a start of the illumination. As a result, a particular visible distance range can be captured by the optical sensor by the temporal actuation of the at least one lighting device, on the one hand, and of the optical sensor, on the other hand, with the correspondingly defined spatial position, i.e., in particular at specific distances of a near and a far boundary of the visible distance region of the optical sensor. A spatial position of the optical sensor and of the at least one lighting device is known from the installation of the gated camera. Preferably, a spatial distance between the at least one lighting device and the optical sensor is also known and is small in comparison to the distance of the at least one lighting device or of the optical sensor to the visible distance region. Thus, in the context of the present technical teaching, a distance between the optical sensor and the visible distance region is the same as a distance between the gated camera and the visible distance region.

The visible distance region is therefore that—object-side—region in three-dimensional space which is imaged by means of the optical sensor in a two-dimensional recording on an image plane of the optical sensor by the number and the duration of the light pulses of the at least one lighting device and the start of the illumination in connection with the start and the end of the exposure of the optical sensor.

Insofar as the term “object-side” is used here and in the following, this refers to a region in real space. Insofar as the term “image-side” is used here and in the following, this refers to a region on the image plane of the optical sensor. The visible distance region is given with regard to the object side. This corresponds to an image-side region on the image plane which is assigned by the imaging laws as well as by the temporal actuation of the at least one lighting device and of the optical sensor.

Depending on the start and end of the exposure of the optical sensor after the beginning of the illumination by the at least one lighting device, the light pulse photons strike the optical sensor. The further the visible distance region is from the at least one lighting device and the optical sensor, the longer the duration until a photon, which is reflected in this region, strikes the optical sensor. Thus, the temporal distance between the end of the illumination and a beginning of the exposure is extended, the further the visible distance region is from the at least one lighting device and from the optical sensor.

The at least one lighting device has at least one surface emitter, in particular a so-called VCSE laser, in a preferred embodiment. Alternatively, or additionally, the optical sensor is preferably a camera.

Preferably, the at least one rotational axis is aligned orthogonal to a driving direction of the motor vehicle and parallel to a road, on which the motor vehicle drives.

In a preferred embodiment, it is provided to use the gated camera in a motor vehicle, in particular in a heavy goods vehicle, in particular in a self-driving heavy goods vehicle, in order to illuminate an object with a height of at most 1 m at a distance of at most 100 m. Furthermore, preferably the at least one rotational axis is aligned orthogonal to a driving direction of the motor vehicle and parallel to a road, on which the motor vehicle drives. The result is that preferably the far boundary of the visible distance region has a distance of at most 100 m from the optical sensor. In a static scene—in particular if the road has a horizontal course—this results in a vertical minimum opening angle αₘᵢₙ of the at least one lighting device of about 0.6°. In a dynamic scene, for further calculation of a vertical opening angle α_{fix}, it is preferably assumed that the motor vehicle has an angle of inclination γ_{N} of at most 1° when emergency braking. Additionally, it is assumed that a road gradient ß of the road can vary by at most 1.5° from a horizontal course. Considering these basic conditions and an installation angle μ, the following results for a conventional lighting device as a vertical opening angle α_{fix}:

α_{fix}=αₘᵢₙ+2β+γ_{N}−μ=4.6°−μ/l (1)

Preferably, the installation angle μ is from at least 0° to at most 0.5°. For a gated camera which has at least one lighting device rotationally mounted around a horizontal rotational axis in relation to the optical sensor, it is not necessary to consider the preceding basic conditions regarding the angle of inclination γ_{N}, the road gradient β and the installation angle μ, as the at least one lighting device can be adapted to these basic conditions by means of rotation around the rotational axis. With the addition of a security angle range of 0.4° to the gated camera according to the invention, it is advantageously possible to increase the efficiency of the at least one lighting device by a factor of 4. In particular, preferably a light pulse photon density can be increased in the lighting frustum by at least the factor of 4, due to the reduction of the vertical opening angle of the lighting frustum. Alternatively, a number of light pulse photons can preferably be reduced in the lighting frustum by the factor of 4, preferably with a fixed light pulse photon density.

In the context of the present technical teaching, both a gradient, as well as a slope of the road are understood by the term “road gradient.”

In a further preferred embodiment, preferably the rotational axis is aligned orthogonal to the road. Depending on a road curvature—in particular at a right-hand bend or a left-hand bend—preferably a horizontal opening angle of the at least one rotatable lighting device can be chosen to be smaller by the factor of 2 than the horizontal opening angle of a conventional lighting device.

According to a further development of the invention, it is provided that the gated camera has a movement device which is set up in order to rotate the at least one lighting device around the at least one rotational axis in relation to the optical sensor. Advantageously, it is possible by means of the movement device to dynamically illuminate the user-defined regions of the object-side scene.

In a preferred embodiment, the movement device has an actuator and a link, wherein the actuator and the link are connected with the at least one lighting device in such a way that the latter is rotatable by means of a change in length of the actuator in connection with the link.

In an alternative preferred embodiment, the movement device has the actuator and a rod, wherein the rod extends along the rotational axis, wherein the at least one lighting device is positioned on the rod and the actuator is set up for rotating the rod. Thus, the at least one lighting device is rotated by means of the actuator when the rod rotates.

According to a further development of the invention, it is provided that the at least one lighting device is mounted rotatably around two rotational axes relative to the optical sensor. Preferably, a first rotational axis of the two rotational axes and a second rotational axis of the two rotational axes are aligned orthogonal to each other. Advantageously, it is thus possible to rotate the at least one lighting device in two directions. Thus, preferably, the vertical opening angle and the horizontal opening angle of the lighting frustum can be changed, in particular reduced, and thus the efficiency of the at least one lighting device can be additionally increased.

In a preferred embodiment, the gated camera, in particular the movement device, has two actuators for rotating the at least one lighting device. In particular, the movement device is formed as a biaxial gimbal system.

According to a further development of the invention, it is provided that the gated camera has a first lighting device and a second lighting device as the at least one lighting device. The first lighting device and the second lighting device are coupled such that they are each simultaneously rotatable around at least one rotational axis relative to the optical sensor.

In a preferred embodiment, the first lighting device is rotatable around a first first rotational axis and the second lighting device is rotatable around a second first rotational axis. In addition, preferably, the first first rotational axis and the second first rotational axis are aligned parallel to each other, particularly preferably the first first rotational axis and the second first rotational axis are identical.

In a further preferred embodiment, both the first lighting device and also the second lighting device each are rotatably mounted in relation to a first rotational axis and a second rotational axis, relative to the optical sensor. Preferably, the first lighting device is rotatable around the first first rotational axis and a first second rotational axis. In addition, preferably, the second lighting device is rotatable around the second first rotational axis and a second second rotational axis. In addition, preferably, the first first rotational axis and the second first rotational axis are aligned parallel to each other, particularly preferably the first first rotational axis and the second first rotational axis are identical. Alternatively, or additionally, the first second rotational axis and the second second rotational axis are aligned parallel to each other, particularly preferably the first second rotational axis and the second second rotational axis are identical.

In a further preferred embodiment, the first lighting device is rotatable around the first first rotational axis and the first second rotational axis. In addition, preferably, the second lighting device is rotatable around the second first rotational axis and the second second rotational axis. Additionally, preferably, the first first rotational axis and the second first rotational axis are identical. Alternatively, or in addition, the first second rotational axis and the second second rotational axis are aligned parallel to each other and are separated from each other.

In a particularly preferred embodiment, the first lighting device is rotatable around the first first rotational axis and the first second rotational axis. In addition, preferably, the second lighting device is rotatable around the second first rotational axis and the second second rotational axis. Additionally, preferably, the first first rotational axis and the second first rotational axis are identical and are aligned orthogonal to the driving direction of the motor vehicle and parallel to the road. Alternatively, or in addition, the first second rotational axis and the second second rotational axis are aligned orthogonal to the road, separated from each other and parallel to each other.

The object is also solved by providing a control device which is set up in order to specify and preferably adjust a rotation, in particular a rotational angle, of the at least one lighting device of a gated camera according to the invention or of a gated camera according to one or more of the aforementioned embodiments in relation to the at least one rotational axis, depending on at least one parameter. The control device is preferably formed as a computing device, particularly preferably as a computer, or as a control unit, in particular as a control unit of a motor vehicle. In connection with the control device, the advantages in particular arise which have already been stated in connection with the gated camera.

The control device is preferably set up in order to be operatively connected with the gated camera, in particular with the at least one lighting device and the optical sensor, and set up for their respective actuation. In addition, the control device is preferably set up in order to be operatively connected with the movement device and set up to actuate the latter.

The object is also solved by providing a gated camera apparatus which has a gated camera according to the invention or a gated camera according to one or more of the aforementioned embodiments and a control device according to the invention or a control device according to one or more of the aforementioned embodiments. In connection with the gated camera apparatus, the advantages in particular arise which have already been stated in connection with the gated camera and the control device.

In a preferred embodiment, the gated camera apparatus additionally has the movement device.

The control device is preferably operatively connected with the gated camera, in particular with the at least one lighting device and the optical sensor, and set up for their respective actuation. In addition, the control device is preferably operatively connected with the movement device and set up to actuate the latter.

The object is also solved by providing a motor vehicle with a gated camera according to the invention or a gated camera according to one or more of the aforementioned embodiments and a control device. The control device is set up in order to specify the rotation, in particular the rotational angle, of the at least one lighting device in relation to the at least one rotational axis, depending on at least one parameter. Alternatively, the motor vehicle has a gated camera apparatus according to the invention or a gated camera apparatus according to one or more of the aforementioned embodiments. In connection with the motor vehicle, the advantages in particular arise which have already been stated in connection with the gated camera.

Preferably, the at least one parameter is selected from a group consisting of a pitch angle of the motor vehicle, a yaw angle of the motor vehicle, the road gradient, and the road curvature.

In a preferred embodiment, the motor vehicle is a self-driving motor vehicle. Alternatively, or additionally, the motor vehicle is preferably a heavy goods vehicle. It is however also possible that the motor vehicle is a passenger car, a utility vehicle, or another motor vehicle.

The object is also solved by providing a method for operating a gated camera according to the invention or a gated camera according to one or more of the aforementioned embodiments in a motor vehicle. In this case, at least one parameter of the motor vehicle and/or the road is determined, wherein on the basis of the at least one parameter, a rotation, in particular a rotational angle, of the at least one lighting device in relation to the at least one rotational axis is specified and/or set. In connection with the method, the advantages in particular arise which have already been stated in connection with the gated camera, the control device, the gated camera apparatus, and the motor vehicle. Advantageously, by means of the method, an alignment of the at least one lighting device can be dynamically adapted to the road and/or the motor vehicle based on the at least one parameter.

According to a further development of the invention, it is provided that the at least one parameter is selected from a group consisting of the pitch angle of the motor vehicle, the yaw angle of the motor vehicle, the road gradient, and the road curvature.

According to a further development of the invention, it is provided that the first rotational axis is selected such that it is aligned orthogonal to the driving direction of the motor vehicle and parallel to the road.

According to a further development of the invention, it is provided that the second rotational axis is selected such that it is aligned orthogonal to the road.

According to a further development of the invention, it is provided that the at least one lighting device is rotated at a first rotational angle in relation to the first rotational axis, depending on the pitch angle of the motor vehicle and/or of the road gradient. Alternatively, or additionally, the at least one lighting device is rotated at a second rotational angle in relation to the second rotational axis, depending on the yaw angle of the motor vehicle and/or the road curvature.

The invention is illustrated in greater detail below by means of the drawings.

### BRIEF DESCRIPTION OF THE DRAWINGS

FIG. 1 is a schematic representation of a first exemplary embodiment of a gated camera;

FIG. 2 is a schematic representation of a second exemplary embodiment of the gated camera;

FIG. 3 is a schematic representation of a third exemplary embodiment of the gated camera;

FIG. 4 is a schematic representation of a first exemplary embodiment of a motor vehicle;

FIG. 5 is a schematic representation of a second exemplary embodiment of the motor vehicle; and

FIG. 6 is a schematic representation of a flow chart of an exemplary embodiment of a method for operating the gated camera.

### DETAILED DESCRIPTION OF THE DRAWINGS

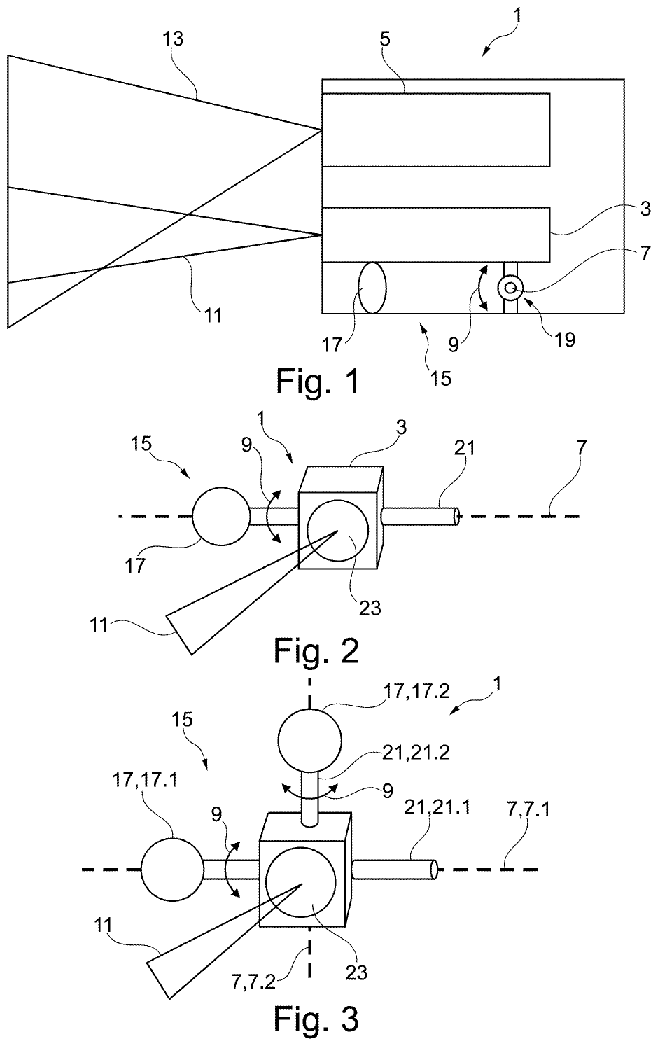

FIG. 1 shows a schematic representation of a first exemplary embodiment of a gated camera 1. The gated camera 1 has at least one lighting device 3 and an optical sensor 5. The at least one lighting device 3 has at least one degree of freedom such that the at least one lighting device 3 is rotatably mounted in relation to the at least one rotational axis 7 relative to the optical sensor. The at least one rotational axis 7 stands perpendicular to the drawing plane in FIG. 1. That the at least one lighting device 3 is rotatable, is represented by means of an arrow 9.

Furthermore, in FIG. 1 a lighting frustum 11 of the at least one lighting device 3 and an observation region 13 of the optical sensor is represented.

Preferably, the gated camera 1 has a movement device 15, which is set up in order to displace the at least one lighting device 3 in relation to the at least one rotational axis 7. Particularly preferably, the movement device 15 of the first exemplary embodiment of the gated camera 1 has an actuator 17 and a joint 19. A change of length of the actuator 17 in a vertical direction is converted into a rotation of the at least one lighting device 3 around the at least one rotational axis 7 by means of the joint 19.

FIG. 2 exhibits a schematic representation of a second exemplary embodiment of the gated camera 1.

The same elements and elements with the same function are provided with the same reference numerals in all figures, so that reference is made to the preceding description in this respect.

Preferably, the movement device 15 has the actuator 17 and a rod 21. The rod 21 is preferably arranged along the at least one rotational axis 7 and additionally the at least one lighting device 3 is fixed on the rod 21. The rod 21 is rotated by means of the actuator 17, whereby the at least one lighting device 3 is likewise rotated.

Preferably, the at least one lighting device 3 has a surface emitter 23, in particular a laser, in particular a VCSE laser.

FIG. 3 shows a schematic representation of a third exemplary embodiment of the gated camera 1.

Preferably, the at least one lighting device 3 is rotatably mounted in relation to two rotational axes 7. Particularly preferably, a first rotational axis 7.1 of the two rotational axes 7 and a second rotational axis 7.2 of the two rotational axes 7 are aligned orthogonal to each other.

Particularly preferably, the movement device 15 is designed as a biaxial gimbal system. Thus, the movement device 15 preferably has a first rod 21.1 which is arranged along the first rotational axis 7.1, and a second rod 21.2 which is arranged along the second rotational axis 7.2. The first rod 21.1 is rotated by means of a first actuator 17.1 and the second rod 21.2 is rotated by means of a second actuator 17.2.

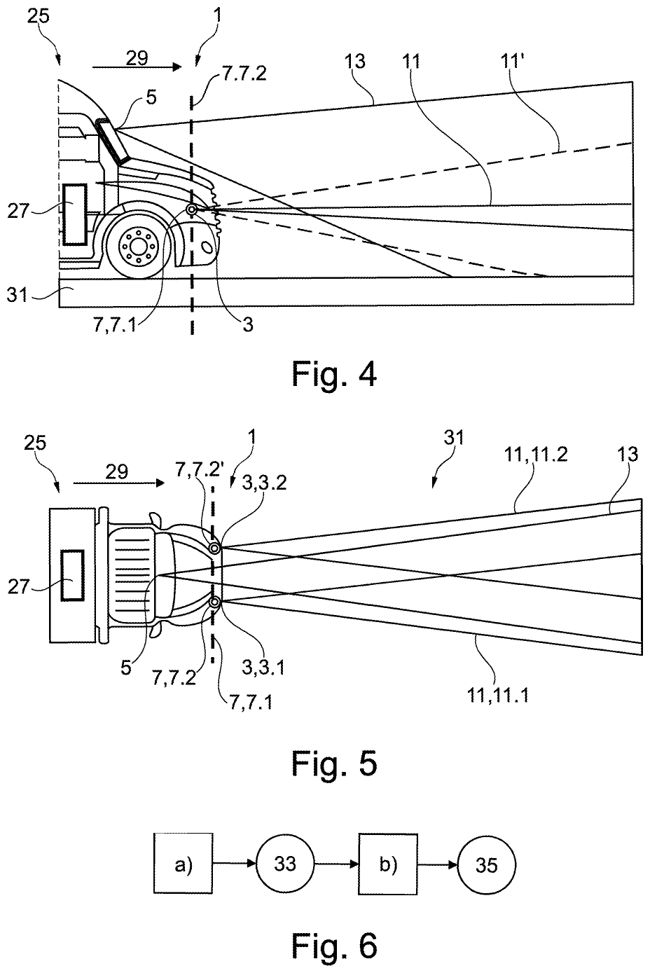

FIG. 4 shows a schematic representation of a first exemplary embodiment of a motor vehicle 25 with a fourth exemplary embodiment of the gated camera 1 and a control device 27.

The control device 27 is operatively connected with the gated camera 1 and set up to actuate the latter in a manner that is not explicitly shown. In addition, the control device is set up in order to specify a rotation, in particular a rotational angle, of the at least one lighting device 3 in relation to the at least one rotational axis 7, depending on at least one parameter.

Drawn in addition to the lighting frustum 11 of the at least one lighting device 3, is a conventional lighting frustum 11′ of a conventional lighting device. This shows that a vertical opening angle of the lighting frustum 11 can be chosen to be smaller than a vertical opening angle of the conventional lighting frustum 11′, on the basis of the rotatability of the at least one lighting device 3.

Particularly preferably, the at least one lighting device 3 is rotatably mounted in relation to the first rotational axis 7.1 and the second rotational axis 7.2. In addition, preferably, the first rotational axis 7.1 is aligned orthogonal to a driving direction 29 of the motor vehicle 25 and parallel to a road 31. Alternatively, or additionally, preferably, the second rotational axis 7.2 is aligned orthogonal to the road 31.

FIG. 5 shows a schematic representation of a second exemplary embodiment of the motor vehicle 25 with a fifth exemplary embodiment of the gated camera 1 and of the control device 27.

The gated camera 1 has a first lighting device 3.1 and a second lighting device 3.2 as the at least one lighting device 3. Particularly preferably, the first lighting device 3.1 and the second lighting device 3.2 are coupled in such a way that they are each simultaneously rotatable around at least one rotational axis 7—in particular the first rotational axis 7.1 and/or the second rotational axis 7.2.

In particular, the first lighting device 3.1 has the first rotational axis 7.1 and a first second rotational axis 7.2. Additionally, the second lighting device 3.2 in particular has the first rotational axis 7.1 and a second second rotational axis 7.2′. Preferably, the first second rotational axis 7.2 and the second second rotational axis 7.2′ are aligned parallel to each other.

The first lighting device 3.1 preferably generates a first lighting frustum 11.1. Alternatively, or additionally, preferably, the second lighting device 3.2 generates a second lighting frustum 11.2.

Preferably, the control device 27 is operatively connected both with the first lighting device 3.1 and also with the second lighting device 3.2 and set up for their respective actuation in a manner that is not explicitly shown.

The control device 27 is preferably set up for carrying out a method for operating the gated camera.

FIG. 6 shows a schematic representation of a flow chart of an exemplary embodiment of the method for operating the gated camera 1 in a motor vehicle 25.

In a first step a), at least one parameter 33 of the motor vehicle 25 and/or of the road 31 is determined. Preferably, the at least one parameter 33 is selected from a group consisting of a pitch angle of the motor vehicle 25, a yaw angle of the motor vehicle 25, a road gradient, and a road curvature.

In a second step b), a rotation, in particular a rotational angle 35, of the at least one lighting device 3 is specified and/or set in relation to the at least one rotational axis 7, on the basis of the at least one parameter 33.

Preferably, the first axis 7.1 is chosen such that it is aligned orthogonal to the driving direction 29 of the motor vehicle 25 and parallel to the road 31. Alternatively, or additionally, the second axis 7.2 is chosen such that it is aligned orthogonal to the road 31.

Particularly preferably, in the third step c), the at least one lighting device 3 is rotated at a first rotational angle 35.1 in relation to the first rotational axis 7.1, depending on the pitch angle of the motor vehicle 25 and/or the road gradient. Alternatively, or additionally, the at least one lighting device 3 is rotated particularly preferably at a second rotational angle 35.2 in relation to the second rotational axis 7.2, depending on the yaw angle of the motor vehicle 25 and/or the road curvature.

1.-10. (canceled)

11. A gated camera (1), comprising:
at least one lighting device (3); and
an optical sensor (5);
wherein the at least one lighting device (3) has at least one degree of freedom such that the at least one lighting device (3) is rotatably mounted in relation to at least one rotational axis (7) relative to the optical sensor (5).

12. The gated camera (1) according to claim 11, further comprising a movement device (15), wherein the movement device is set up to displace the at least one lighting device (3) in relation to the at least one rotational axis (7).

13. The gated camera (1) according to claim 11, wherein the at least one lighting device (3) is rotatably mounted in relation to two rotational axes (7) and wherein a first rotational axis (7.1) of the two rotational axes (7) and a second rotational axis (7.2) of the two rotational axes (7) are aligned orthogonal to each other.

14. The gated camera (1) according to claim 11, wherein the at least one lighting device (3) is a first lighting device (3.1) and a second lighting device (3.2) and wherein the first lighting device (3.1) and the second lighting device (3.2) are coupled such that they are each simultaneously rotatable around the at least one rotational axis (7).

15. A motor vehicle (25), comprising:
the gated camera (1) according to claim 11; and
a control device (27) which is set up to specify a rotational angle of the at least one lighting device (3) in relation to the at least one rotational axis (7) depending on at least one parameter (33).

16. A method for operating the gated camera (1) according to claim 11 in a motor vehicle (25), comprising the steps of:
determining at least one parameter (33) of the motor vehicle (25) and/or of a road (31); and
wherein a rotational angle (35) of the at least one lighting device (3) is specified and/or set in relation to the at least one rotational axis (7) on a basis of the at least one parameter (33).

17. The method according to claim 16, wherein the at least one parameter (33) is a pitch angle of the motor vehicle (25) or a yaw angle of the motor vehicle (25) or a road gradient or a road curvature.

18. The method according to claim 17, wherein a first rotational axis (7.1) of the at least one rotational axis (7) is selected such that it is aligned orthogonal to a driving direction (29) of the motor vehicle (25) and parallel to the road (31).

19. The method according to claim 18, wherein a second rotational axis (7.2) of the at least one rotational axis (7) is selected such that it is aligned orthogonal to the road (31).

20. The method according to claim 19, wherein the at least one lighting device (3) is rotated by a first rotational angle (35.1) in relation to the first rotational axis (7.1), depending on the pitch angle of the motor vehicle (25) and/or the road gradient, and/or wherein the at least one lighting device (3) is rotated by a second rotational angle (35.2) in relation to the second rotational axis (7.2), depending on the yaw angle of the motor vehicle (25) and/or the road curvature.
